(19) United States
(12) Patent Application Publication
(10) Pub. No.: US 2016/0335623 A1
(43) Pub. Date: Nov. 17, 2016

(54) Reverse Payment Flow

(71) Applicant: PAYPAL, INC., San Jose, CA (US)

(72) Inventors: Sebastien Taveau, Redwood City, CA (US); Eric Duprat, Los Altos, CA (US)

(21) Appl. No.: 15/217,750

(22) Filed: Jul. 22, 2016

Related U.S. Application Data
(63) Continuation of application No. 13/093,308, filed on Apr. 25, 2011.
(60) Provisional application No. 61/328,111, filed on Apr. 26, 2010.

(51) Int. Cl. G06Q 20/32

(52) U.S. Cl. CPC G06Q 20/3278; G06Q 20/3224; G06Q 20/3255

(57) ABSTRACT

Systems and methods for facilitating transactions using contactless proximity communication technology include information or payment flows that are reversed from the conventional sense in that information may flow in direction from a merchant via a consumer mobile device to a financial services provider (FSP). Such payment and information flows can be accomplished without needing to modify infrastructure—such as point-of-sale NFC readers, mobile handsets, or advertising tags and may provide “bridge solutions” for quickly implementing mobile proximity purchase payments. Embodiments provide for receiving some transaction information at a financial services provider in response to a contactless proximity communication that occurs between either a consumer proximity tag and a merchant device, consumer mobile device and merchant proximity tag, or consumer mobile device and merchant device, in which some of the transaction information flow is reverse; validating the transaction; sending payment confirmation to the merchant; and sending transaction confirmation to the consumer.

### CROSS REFERENCE TO RELATED APPLICATIONS

This application is a continuation of U.S. Ser. No. 13/093,308, filed on Apr. 25, 2011, which claims the benefit of U.S. Provisional Application No. 61/328,111, filed Apr. 26, 2010, both of which are incorporated herein by reference. This application is also related to co-pending U.S. patent application Ser. No. 12/643,972, filed Dec. 21, 2009, entitled “Trusted Integrity Manager (TIM)”, which is incorporated by reference.

### BACKGROUND

1. Technical Field

Embodiments of the present invention generally relate to methods and systems for facilitating commerce and, more particularly, for facilitating the use of mobile devices in commercial and financial transactions.

2. Related Art

Mobile proximity payment, e.g., the capability to make a payment at a point of sale with a handheld mobile device—such as a mobile phone—by bringing the mobile device into proximity (typically within about 4 inches) with either a tag or reader device, has been in development for some time, requiring coordination among key stakeholders including, for example, mobile network operators (MNO), merchants, payment processors, banks, and developers. While near field communication (NFC) technology should help further enable mobile payments, successful and established mobile technologies, including SMS (Short Message Service) and USSD (Unstructured Supplementary Service Data), are currently leading the development in payments ecosystems. Delivery of NFC enabled handsets has been limited in volume and accompanied by limited functionalities of those handsets, however, and players in the payments ecosystems have been looking for alternative solutions, also called “bridge solutions.”

The most common solutions that have been explored use the contactless sticker (e.g., a radio frequency identification (RFID) tag or NFC-enabled sticker). Many pilot programs using contactless stickers for mobile payment have been conducted around the world. Most of the solutions, however, consistently assume that the consumer is to be the holder of the sticker and the merchant is to have a point of sale (POS) reader that is enabled to read the sticker, or “tag” as the sticker is commonly referred to. Furthermore, current deployments of stickers are typically for a single provider and limited to a “card emulation mode”, in which the NFC device behaves like an existing (e.g., currently known and used technology) contactless card (hence the name “passive” stickers or tags). NFC devices may also be used in a “reader mode”, in which the NFC device is active (e.g., able to both transmit and receive information) and reads a passive RFID tag, for example for interactive advertising; and NFC devices may also be used in a “P2P mode” (e.g., “peer-to-peer”), in which two NFC devices are active, communicate together, and exchange information.

### SUMMARY

According to one or more embodiments of the present invention, methods and systems for mobile payments include ways to improve the payment and information flow in mobile proximity payment transactions—e.g., transactions using contactless proximity communication technology, such as near field communication (NFC)—including information or payment flows that are reversed from the conventional sense in that information may flow in a direction from a merchant via a consumer mobile device to a financial services provider. Such payment and information flows in mobile proximity payment transactions may provide innovative ways to process payments on the behalf of a consumer and a merchant that can be accomplished without needing to modify the infrastructure—such as point-of-sale (POS) NFC readers, mobile handsets, or advertising tags and may provide “bridge solutions” for quickly implementing mobile proximity purchase payments.

In one or more embodiments, a system includes: a network computing device of a financial service provider (FSP) for communicating with a consumer mobile device and a merchant device. In response to a contactless proximity communication between either a consumer proximity tag and the merchant device, or the consumer mobile device and a merchant proximity tag, or the consumer mobile device and the merchant device, some transaction information is sent to the FSP via the consumer mobile device; the FSP network computing device validates the transaction information; the FSP network computing device sends a payment credit confirmation to the merchant device; and the FSP network computing device sends a transaction confirmation message to the consumer mobile device.

In another embodiment, a computer-implemented method includes: receiving some transaction information at a financial services provider (FSP) in response to a contactless proximity communication that occurs either between a consumer proximity tag and a merchant device, between a consumer mobile device and a merchant proximity tag, or between the consumer mobile device and the merchant device, in which at least a portion of the transaction information flows in a direction from the consumer mobile device to the FSP; validating, by the FSP, the transaction information; sending a payment credit confirmation from the FSP to the merchant device; and sending a transaction confirmation message from the FSP to the consumer mobile device.

In a further embodiment, a computer program product comprises a non-transitory computer readable medium having computer readable and executable code for instructing a processor to perform a method that includes: receiving some transaction information at a financial services provider (FSP) in response to a contactless proximity communication that occurs either between a consumer proximity tag and a merchant device, between a consumer mobile device and a merchant proximity tag, or between the consumer mobile device and the merchant device, wherein at least a portion of the transaction information flows in a direction from the consumer mobile device to the FSP; validating, by the FSP, the transaction information; sending a payment credit confirmation from the FSP to the merchant device; and sending a transaction confirmation message from the FSP to the consumer mobile device.

### BRIEF DESCRIPTION OF THE DRAWINGS

FIG. 1A and FIG. 1B are system diagrams illustrating a comparison between active tag and passive tag process flows in accordance with one or more embodiments.

FIG. 2A is a system diagram illustrating a system for providing a proximity payment using a consumer mobile device with a proximity tag and a merchant device in accordance with an embodiment of the invention;

FIG. 2B is a flow chart illustrating a method for providing a proximity payment in a system such as the system illustrated in FIG. 2A in accordance with an embodiment;

FIG. 3A is a system diagram illustrating a system for providing a proximity payment using a consumer mobile device and a merchant having a proximity tag and a secondary device in accordance with an embodiment of the invention;

FIG. 3B is a flow chart illustrating a method for providing a proximity payment in a system such as the system illustrated in FIG. 3A in accordance with an embodiment;

FIG. 4A is a system diagram illustrating a system for providing a proximity payment using a consumer mobile device and a merchant device in accordance with an embodiment of the invention; and

FIG. 4B is a flow chart illustrating a method for providing a proximity payment in a system such as the system illustrated in FIG. 4A in accordance with an embodiment.

### DETAILED DESCRIPTION

Embodiments of the present invention relate to methods and systems for providing a service that facilitates purchases via mobile proximity payments using, for example, a mobile phone handset or other personal digital device, a sticker or RFID tag, which may be active or passive, and a reader or tag which may be active or passive, at a point of sale (POS) for example, or advertising display. One or more embodiments may provide the “bridge solutions” referred to above and may provide solutions without the need to modify the infrastructure—such as POS NFC readers, mobile handsets, or tags embedded in advertising displays.

In one or more embodiments, a mobile proximity payments service may be provided by a financial service provider (FSP)—such as PayPal, Inc. of San Jose, Calif.—in which a consumer or vendor using the service may have an account with the FSP (referred to as an “FSP account”). Using such a service, according to one or more embodiments, payments may be accomplished using payment and information flows that conventionally would not be expected—such as flows between the consumer and FSP instead of a flow for the same information between the vendor and the FSP, for example, or a flow of information from the vendor through the consumer device to the FSP that is “reverse” in direction from what would be conventionally expected. Broadly, there are three cases that may be described for solutions using these proximity payment information flows in accordance with one or more embodiments.

In a first case, consumers may receive a sticker having an RFID or NFC capability (various NFC-enabled form factors—such as tags, stickers, key fobs, or cards that do not require batteries, for example—all may be referred to herein as “proximity tags”) and merchants may have the infrastructure to read the tag (e.g., tag reader, devices for processing information from the tag, lines of communication to the FSP, and established accounts). For example, the consumer proximity tag may operate in card emulation mode and the merchant infrastructure may operate in reader mode. A novel aspect of a solution according to the first case is that it may accept or create an acceptance network of the FSP at the merchant side of a transaction, in accordance with one or more embodiments.

In a second case, the merchant may be provided with the proximity tag (e.g., a sticker having an RFID or NFC capability) and the transaction is controlled through a consumer handset that is enabled for reader mode and can read the merchant proximity tag. For example, the consumer may input some data into the handset that usually is automatically inserted by the POS device (e.g., purchase amount, tips); the merchant may have to trust the consumer is entering the correct data; but this is compensated for by instant confirmation to the merchant via a secondary device which may be connected (e.g., via an internet protocol (IP) network) to the FSP, hence the name “reverse flow” of payments or information.

The novel “reverse flow” solution may allow a quick deployment of both merchant location and consumer devices for payment, providing essential elements of matching a merchant to a consumer based on location and identification. The consumer handset need not be a fully NFC integrated handset, but may be, for example, a phone with an NFC micro-SD (Secure Digital) card that is enabled for reader mode or P2P. The consumer handset may thus provide information such as the merchant tag number identification (ID) and the consumer's (which will also be the merchant's) location that may used, for example, for authenticating the consumer, the merchant, and the transaction by the FSP. The merchant proximity tag may be passive (e.g., simply responding to received input signals) or active (e.g., able to transmit information back to the system). The merchant may be registered with the FSP as having and using the merchant proximity tag unique to the merchant (for example, tags may be numbered). The merchant may also have a secondary, IP-connected device (e.g., personal computer (PC), tablet, or non-NFC enabled phone) to concurrently connect to the FSP and receive the confirmation that the payment has been sent to the merchant's FSP account by the consumer that just read the merchant's proximity tag.

In one embodiment, for example, using a passive proximity tag, the consumer may feel some inconvenience at having to input some data (e.g., payment amount, tips) that may automatically be inserted by the POS using an active proximity tag (which may be BlueTooth® enabled, or Wi-Fi®, for example) or using any other wireless or contactless means. Passive tags may well-suited, however, for fixed price purchases—such as fixed menus in fast-food restaurants, transit fares, charitable contributions, or museum tickets, to name a few examples. In other embodiments, the consumer may feel less inconvenience as an active proximity tag may be able to provide the necessary input. In another embodiment, the consumer may acquire the merchant ID tag number and send that information back to the FSP; the FSP may then pull from the merchant's secondary, IP-connected device the amount of the transaction and itemization of products purchased, send that information back to the consumer for validation and approval, and deliver confirmation immediately to the merchant. Solutions—including bridge solutions and other solutions for early deployment, fast enabling, and parallel technology—employing embodiments with such back-and-forth intensive usage of network connectivity (e.g., public switched telephone network (PSTN) and Internet), while once seemingly impractical, have become achievable with the advent of always-on, data intensive portable devices.

In a third case, both consumer and merchant may have an NFC, or other contactless, communication-enabled device. Contrary to conventional transactions, however, embodiments may employ “reverse flow” of information and payments in which the consumer may be in control the transaction from the consumer's device by entering information that is sent to the FSP, providing, for example, an entry point to the consumer's virtual “wallet” maintained by the FSP in the “cloud”. In this case of reverse flow, however, in which both consumer and merchant devices may operate in P2P mode, the merchant may be able to share data with the consumer in a more robust and constant state. For example, a device state of being always-on and connected to the system of the FSP may enable the FSP to provide services to both merchant and consumer that may include, for example, allowing the management by the FSP of a real dynamic “wallet” for the consumer. Services provided by the FSP may include ID management, transaction logs and storage, automatic warranty enrollment, and products data information and registration, for example. In an alternative embodiment in which both consumer and merchant devices may operate in P2P mode, the merchant may be in control of the transaction, depending, for example, on a relative advantage provided by either the merchant or the consumer device. Thus, the FSP may be enabled to provide a best choice option of information flow for the consumer, the merchant, and the FSP that can be used to customize information flow in each situation as needed.

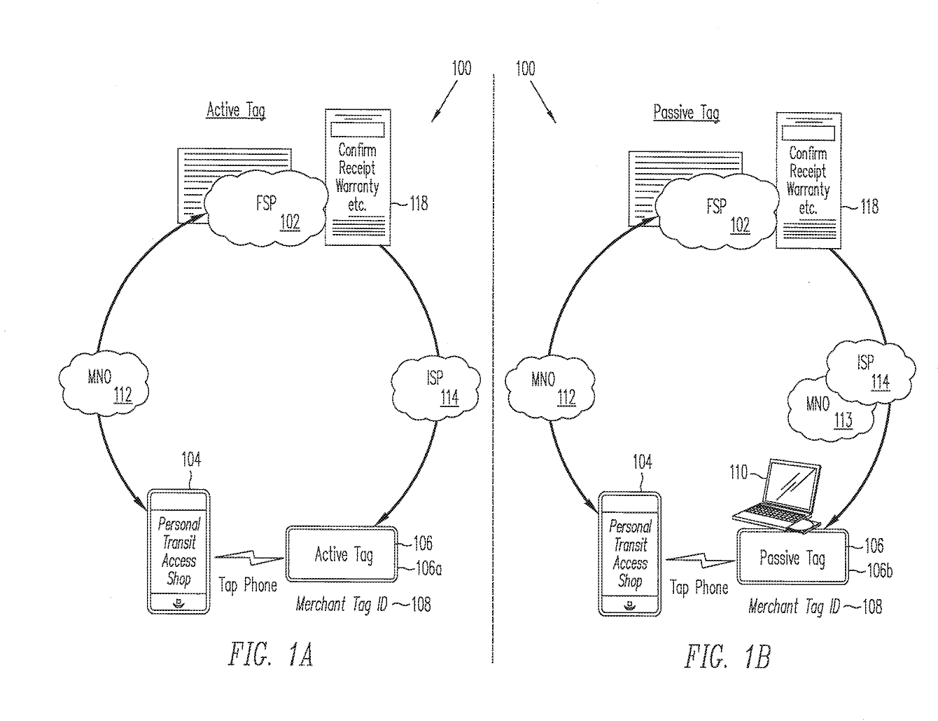

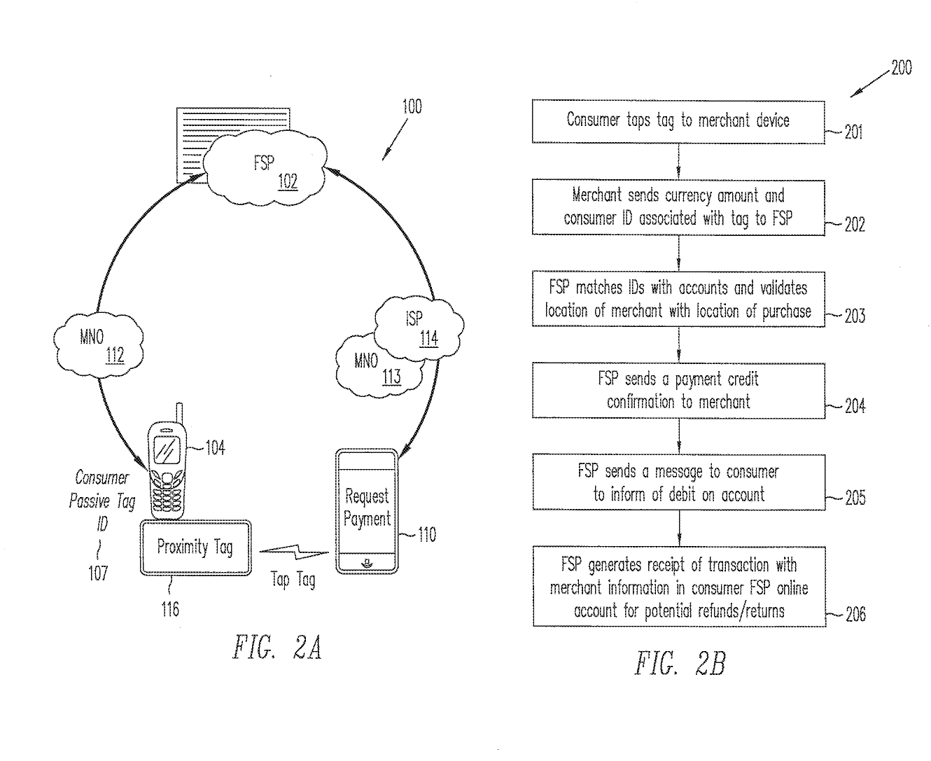

FIG. 1A and FIG. 1B show a system 100 for facilitating the use of mobile devices in commercial and financial transactions (including response to advertising) using contactless proximity communication technology such as NFC tags and readers. System 100 may include a financial services provider (FSP) 102 that may provide a number of services enabling, for example, mobile proximity payments and other types of transactions from a consumer mobile device 104 (such as a mobile phone). Proximity tag 106 may be either an active tag 106a (FIG. 1A) or a passive tag 106b (FIG. 1B). Data may be retrieved from the proximity tag 106 by bringing the mobile device 104 into proximity (typically less than 4 inches) with the proximity tag 106 as indicated in the figures by the lightning bolt and the legend “tap phone”. Data retrieved from the proximity tag 106 may include a unique identifying symbol sequence indicated in the figures as “merchant tag ID” 108. The unique identifying symbol sequence of merchant tag ID 108 may be in either a hard or soft format (e.g., either “hard-coded” into each tag or programmable into each tag as the tag is deployed).

Upon retrieving the merchant tag ID 108, the mobile device 104 (connected to FSP 102 via a mobile network operator (MNO) 112) may send the merchant tag ID 108 and additional information—such as the value of a counter in the passive or active proximity tag 106, the consumer's FSP account number, authentication, and geo-location—to the FSP 102 for matching, e.g., validation and authentication. The merchant (or other party, e.g., advertiser) user of proximity tag 106 may also be able to communicate with FSP 102 via an IP-connected, secondary device 110 via either of MNO 113 or internet service provider (ISP) 114. Each party (e.g., the consumer or user of mobile device 104 and the merchant or user of active or passive tag 106) may have a registered account with the FSP 102 and a sticker (e.g. proximity tag 106) registered to a specific account, either for the merchant or for the consumer or both. For example, the merchant may receive the confirmation via secondary device 110 that a payment has been sent to the merchant's FSP account by the consumer that just read the merchant's proximity tag; or, in the case of an active tag 106a, there may be direct communication between the active tag 106a and FSP 102 via ISP 114. Successfully completing transactions in a timely manner may require quick, accurate matching, and the FSP account of each party (e.g., the consumer or user of mobile device 104 and the merchant or user of active or passive tag 106) should be credited or debited the proper amount to or from the proper party so that all accounts reconcile. In order to achieve such real-time reconciliation, a system architecture that implements various modules may be implemented by FSP 102. A number of key functions of such a system architecture can be found in co-pending U.S. patent application Ser. No. 12/643,972, filed Dec. 21, 2009, titled “Trusted Integrity Manager (TIM)”, which is incorporated by reference.

Data retrieved—by the mobile device 104, for example, in the case of using a merchant proximity tag, or by the merchant tag reader or active tag 106a in the case of using a consumer device proximity tag—from a proximity tag 106 (which may be in use, for example, by a merchant, an advertiser, or a consumer) may include a unique tag identifier assigned to only that proximity tag (for example, the merchant tag ID 108 belonging to a merchant tag 106 or a consumer tag ID belonging to a consumer tag). The unique tag identifier may, for example, include a number that is physically internal to the tag to avoid its possible duplication or theft and may be included, for example, during manufacture of each tag or programmed in later. Data retrieved from a proximity tag 106 may also include a unique identifier assigned to the entity receiving the tag (e.g., merchant's individual electronic cash register (ECR), a store, a location, or an individual merchant, for example). Data retrieved from a proximity tag 106 may also include a unique identifier to specify the physical (geographical) location of the tag. In addition, in the case of a fixed transaction amount tag, the value (e.g., $5, $10, for example) assigned to the tag may be retrieved.

The foregoing data may be assigned to and included in a passive tag. For an active tag, e.g., proximity tag 106a, additional data may also include a “dynamic” value assigned at the time the transaction amount is compounded. Such a dynamic value may be transmitted to the proximity tag 106a via a channel other than NFC (e.g., BlueTooth). Additional data may also include an element of “authentication” or “validation” that may vary based on the type of reader in the mobile device 104 used by the consumer.

Data read from the proximity tag 106, along with data from the mobile device 104—such as the mobile device ID or ID of a proximity tag attached to the mobile device 104, the consumer ID or password entered, or current geo-location, for example—may be sent by the mobile device 104 to the FSP 102. This data may then be “matched” (e.g., processed for authentication, validation, and accounting) by the FSP 102 between the two FSP accounts—one for the consumer and one for the merchant. The transaction processing by the FSP 102 may include more than that for a standard two-account transaction. For example, a pre-registration for risk consideration and to be accepted by the system 100 may be required. Monitoring for legitimate usage of the proximity tag and accurate consumer input of the transaction information to the mobile device 104 may be required. Additional processing, beyond that for a standard two-account transaction, may be required by the FSP 102 for return and chargeback. Because the consumer will be in charge of the transaction, FSP 102 may be required to keep a transactions log on behalf of each merchant. Consumers may be able to review their history, for example, but the merchants may need to be able to go back to their history and modify it for return or refund, for example. Such issues may be addressed by an adaptive payment or adaptive accounts mechanism implemented by the FSP 102.

FIG. 2A illustrates a portion of a system 100 (see FIG. 1) for facilitating the use of mobile devices in commercial and financial transactions (including response to advertising) using contactless proximity communication technology. As shown in FIG. 2A, a consumer mobile device 104 may be provided with a proximity tag 116, which may be a passive tag. The consumer proximity tag 116 may have a consumer passive tag ID 107 that is uniquely assigned to the consumer proximity tag 116; the passive tag ID 107 may be internal to the consumer proximity tag 116; and the consumer proximity tag 116 may be readable, for example, by merchant secondary, IP-connected device 110. For example, device 110 may be an NFC device or may be a device with an NFC add-on such as a PC USB (universal serial bus) reader. In general, such a consumer passive proximity tag 116 may be provided to a consumer as a readily implementable “bridge solution” for providing mobile proximity payment capability for a mobile device 104 that is not equipped for contactless proximity communication, e.g., not NFC-enabled.

FIG. 2B shows a flow chart for a transaction according to a method 200 that may be accomplished in the embodiment shown in FIG. 2A. At step 201, a consumer (e.g., a user of mobile device 104) may bring the consumer proximity tag 116 into close proximity with a device capable of reading the consumer proximity tag 116 (e.g., merchant device 110, which may have a connection to FSP 102 via an ISP 114 or MNO 113, as shown, or other means) sufficient for the device 110 to read the tag 116. At step 202, the merchant (e.g., merchant device 110 may send transaction information—such as the dollar amount of the transaction and consumer ID, which may be passive tag ID 107, for example—to FSP 102.

At step 203, FSP 102 may authenticate and validate the transaction between the merchant and consumer, for example, by matching the consumer ID with an FSP account of the consumer, matching the merchant ID—which may be provided by device 110 or by a device ID of device 110, for example, with an FSP account of the merchant, and by matching the known location of the merchant (e.g., from merchant's FSP account information) with the location of the purchase derived, for example, from the IP address of IP-connected merchant device 110 or by a Global Positioning System (GPS) geo-location capability of either of consumer device 104 or merchant device 110.

At step 204, the FSP 102 may send a payment credit confirmation to the merchant device 110 via either of ISP 114 or MNO 113. For example, because the FSP 102 may provide accounts to both the consumer and the merchant, the FSP 102 may be able to debit one account and credit the other, and thus provide credit confirmation to the merchant via merchant device 110. Likewise, at step 205, FSP 102 may send the consumer a transaction confirmation message to consumer mobile device 104 to inform the consumer of the debit on the consumer's FSP account. The transaction confirmation message may be sent from a network computing device of FSP 102, for example, to consumer mobile device 104 via a text message using Short Message Service (SMS) or using e-mail. At step 206, FSP 102 may generate a receipt of the transaction for either or both of the consumer's and merchant's FSP account records, with merchant information placed in the consumer's FSP online account for potential refunds or returns.

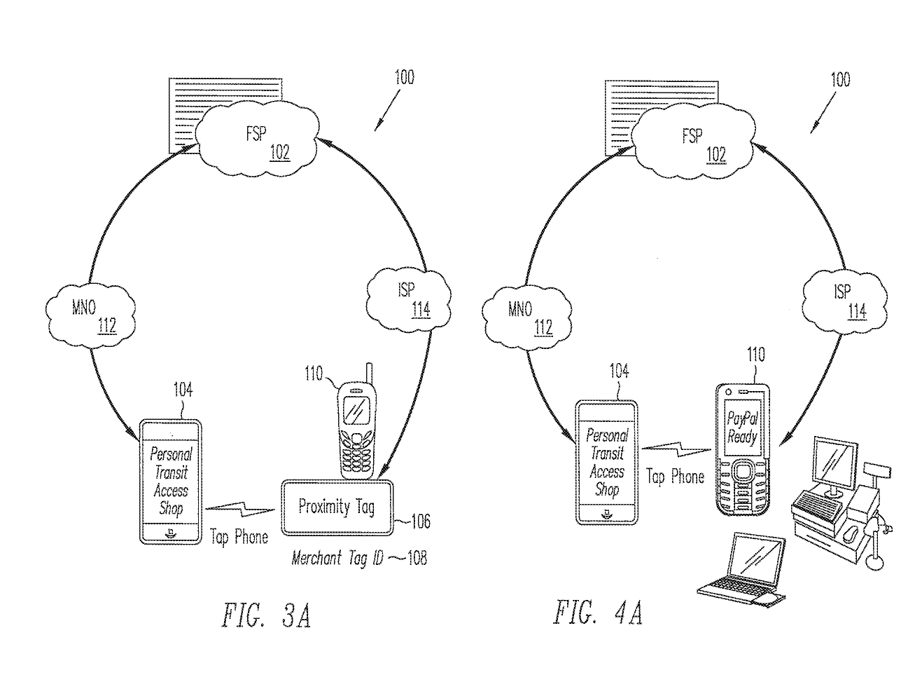

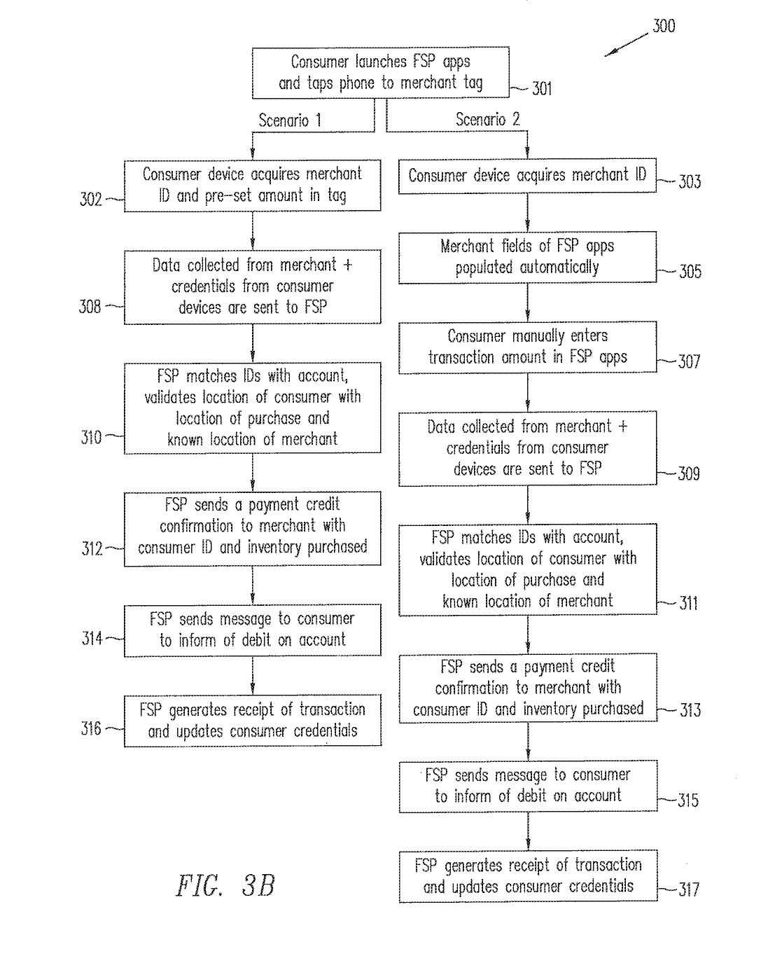

FIG. 3A illustrates a portion of a system 100 (see FIG. 1) for facilitating the use of mobile devices in commercial and financial transactions (including response to advertising) using contactless proximity communication technology.

As shown in FIG. 3A, a merchant may be provided with a proximity tag 106, which may be either a passive or active tag (e.g., active tag 106a or passive tag 106b as shown in FIG. 1). The merchant proximity tag 106 may have a merchant tag ID 108 that is uniquely assigned to the merchant proximity tag 106 or to the merchant. The merchant tag ID 108 may be internal to the merchant proximity tag 106, and the merchant proximity tag 106 may be readable by consumer mobile device 104. For example, consumer mobile device 104 may be an NFC-enabled device or may be a device with an NFC add-on such as a PC USB (universal serial bus) reader. In general, merchant active or passive proximity tags such as tag 106 may be provided to merchants as a readily implementable “bridge solution” for providing mobile proximity payment capability for consumer mobile devices 104 that are equipped for contactless proximity communication when the merchant may not have or be able to readily obtain a device equipped for contactless proximity communication, e.g., an NFC reader.

FIG. 3B shows a flow chart for a transaction according to a method 300 that may be accomplished in the embodiment shown in FIG. 3A. At step 301, a consumer (e.g., a user of mobile device 104) may launch an “app” (application) on consumer mobile device 104. The app may be provided by the FSP 102. The app may, for example, place the consumer mobile device 104, which may be capable of reading a proximity tag 106 using contactless proximity communication technology such as NFC, in a state in which it is ready to read the merchant proximity tag 106 and process the information read from the merchant proximity tag 106, such as storing the information or sending it to FSP 102. The consumer may then bring the consumer mobile device 104 into close proximity with merchant tag 106 sufficient for the consumer mobile device 104 to read the tag 106. Method 300 may then continue according to one of either of two scenarios. In a first scenario (“Scenario 1”) the merchant proximity tag 106 may provide consumer mobile device 104 with a merchant tag ID 108 and, for example, a fixed amount (denoted in a currency, e.g., dollar) for the transaction. Such a fixed amount may come from an advertising poster incorporating a merchant proximity tag 106, for example, a poster advertising a concert or event; or may come, for another example, from a choice of a specific item from a fast food menu. In a second scenario (“Scenario 2”) the merchant proximity tag 106 may provide consumer mobile device 104 with a merchant tag ID 108.

In the first scenario, at step 302, the consumer mobile device 104 may acquire (e.g., via NFC between mobile device 104 and proximity tag 106) the merchant ID (e.g., merchant tag ID 108) and the fixed (e.g., pre-set) amount from the merchant proximity tag 106.

In the second scenario, at step 303, the consumer mobile device 104 may acquire (e.g., via NFC between mobile device 104 and proximity tag 106) the merchant ID (e.g., merchant tag ID 108) from the merchant proximity tag 106. At step 305, merchant information fields of the FSP app launched in step 301 may be populated automatically. Such fields may include information such as the merchant ID, location, product identification, and purchase price, for example. At step 307, in the second scenario, the consumer may manually enter additional information into the FSP app, such as the transaction amount, for example, if not already entered automatically.

In either of the first or second scenarios, at step 308 or step 309, data collected from the merchant (e.g., the information from the merchant proximity tag 106 or information either populated automatically by the FSP app or manually entered into the FSP app) and the credentials from the consumer device (e.g., consumer ID, mobile device 104 ID, or tag ID 107, for example) are sent to the FSP 102. This transaction information may be sent, for example, from consumer mobile device 104 via MNO 112 to FSP 102.

At step 310 or step 311, in scenario 1 or scenario 2, respectively, FSP 102 may authenticate and validate the transaction between the merchant and consumer, as described above. For example, FSP 102 may match the consumer ID with the consumer FSP account and the merchant ID with the merchant FSP account; may validate the location of the consumer with the location of the purchase and the known location of the merchant using, for example, IP addresses or GPS geo-location, as described above.

In either scenario 1 or 2, at step 312 or step 313, the FSP 102 may send a payment credit confirmation to the merchant. As described above, because the FSP 102 may provide accounts to both the consumer and the merchant, the FSP 102 may be able to debit one account and credit the other, and thus provide credit confirmation to the merchant via merchant device 110, and likewise, provide a transaction confirmation message to the consumer via consumer mobile device 104. The payment credit confirmation may include, for example, the amount credited to the merchant's FSP account, with the consumer ID, and the inventory purchased. The payment credit confirmation may be sent, for example, to IP-connected, secondary merchant device 110 using SMS or e-mail. At step 314 or step 315, in scenario 1 or scenario 2 respectively, the FSP 102 may send a transaction confirmation message to the consumer to inform the consumer of the debit on consumer's FSP account. The transaction confirmation message may be sent to consumer mobile device 104, for example, using SMS or email via MNO 112. At step 316 or step 317, respectively in scenario 1 or scenario 2, the FSP 102 may generate a receipt 118 (see FIG. 1) of the transaction for either or both of the consumer's and merchant's FSP account records, with merchant information placed in the consumer's FSP online account for potential refunds or returns, and FSP 102 may update the consumer credentials.

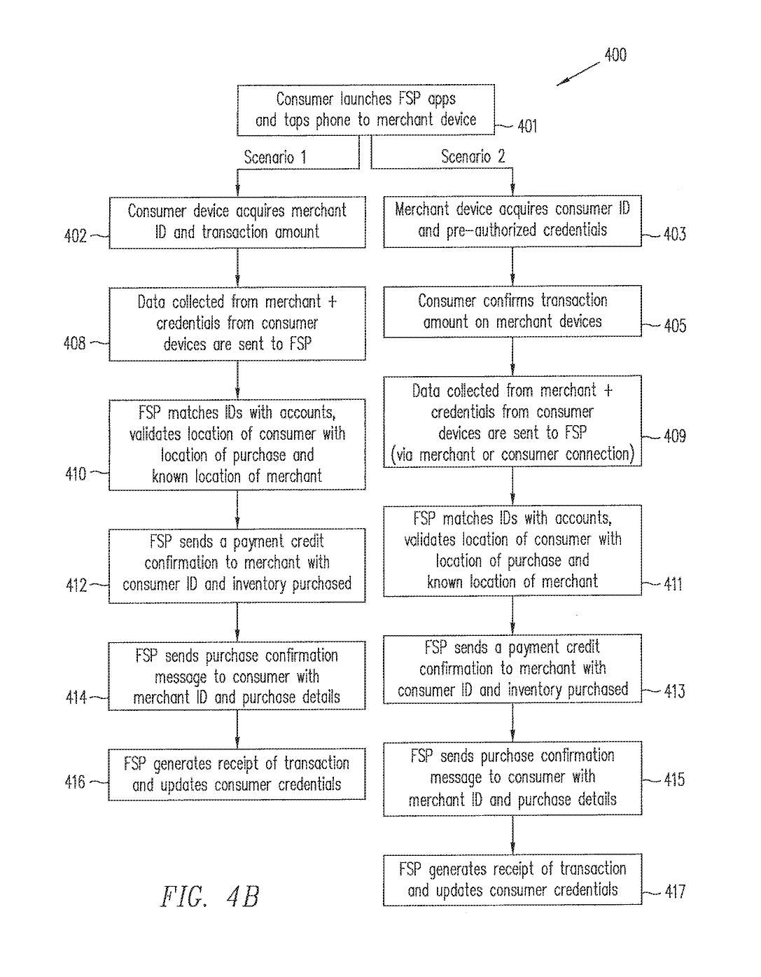

FIG. 4A illustrates a portion of a system 100 (see FIG. 1) for facilitating the use of mobile devices in commercial and financial transactions (including response to advertising) using contactless proximity communication technology. As shown in FIG. 4A, a merchant may provide a contactless proximity communication device, such as merchant device 110, at a point-of-sale. The merchant device 110 may be an NFC-enabled device or may be a device with an NFC add-on such as a PC USB reader. Merchant device 110 may be connected with FSP 102 via an ISP 114 as shown. Similarly, in this case, consumer mobile device 104 may be an NFC-enabled device or may be a device with an NFC add-on such as a PC USB reader. Both the merchant and the consumer may have accounts with the FSP 102 and both may be able to provide credentials, such as a consumer ID and device ID for consumer mobile device 104, or a merchant ID and geo-location and device ID for merchant device 110.

FIG. 4B shows a flow chart for a transaction according to a method 400 that may be accomplished in the embodiment shown in FIG. 4A. At step 401, a consumer (e.g., a user of mobile device 104) may launch an “app” (application) on consumer mobile device 104. The app may be provided by the FSP 102. The app may, for example, place the consumer mobile device 104, which may be capable of communicating with merchant device 110 using contactless proximity communication technology such as NFC, in a state in which it is ready to communicate information with the merchant device 110 and process the information, such as storing the information or sending it to FSP 102. The consumer may then bring the consumer mobile device 104 into close proximity with merchant device 110 sufficient for the consumer mobile device 104 to communicate with merchant device 110. For example, consumer “taps” consumer mobile device 104 to merchant device 110. Method 400 may then continue according to one of either of two scenarios. In a first scenario (“Scenario 1”) the consumer may control the flow of information in that transaction information flow travels via consumer mobile device 104 to FSP 102. In a second scenario (“Scenario 2”) the merchant may control the flow of information in that transaction information flow travels via merchant device 110 to FSP 102.

In the first scenario, at step 402, the consumer mobile device 104 may acquire (e.g., via NFC between consumer mobile device 104 and merchant device 110) the merchant ID (e.g., a device ID from device 110) and a transaction amount, which may be a fixed or pre-set amount from the merchant device 110.

In the second scenario, at step 403, the merchant device 110 may acquire (e.g., via NFC between consumer mobile device 104 and merchant device 110) the consumer ID (e.g., device ID from device 104) or other pre-authorized consumer credentials. At step 405, in the second scenario, the consumer may confirm information, such as the transaction amount, on the merchant device 110, for example, by entering information on a keypad or touch screen.

In either of the first or second scenarios, at step 408 or step 409, data collected from the merchant (e.g., the information from the merchant device 110 or information from the consumer mobile device 104) and the credentials from the consumer device (e.g., consumer ID, mobile device 104 ID, or tag ID 107, for example) may be sent to the FSP 102. This transaction information may be sent, in the first scenario, for example, from consumer mobile device 104 via MNO 112 to FSP 102. The transaction information may be sent, in the second scenario, for example, from merchant device 110 via ISP 114 to FSP 102 or from consumer mobile device 104 via MNO 112 to FSP 102.

At step 410 or step 411, in scenario 1 or scenario 2, respectively, FSP 102 may authenticate and validate the transaction between the merchant and consumer, as described above. For example, FSP 102 may match the consumer ID with the consumer FSP account and the merchant ID with the merchant FSP account; may validate the location of the consumer with the location of the purchase and the known location of the merchant using, for example, IP addresses or GPS geo-location, as described above.

In either scenario 1 or 2, at step 412 or step 413, the FSP 102 may send a payment credit confirmation to the merchant. As described above, because the FSP 102 may provide accounts to both the consumer and the merchant, the FSP 102 may be able to debit one account and credit the other, and thus provide credit confirmation to the merchant via merchant device 110, and likewise, provide a transaction confirmation message to the consumer via consumer mobile device 104. The payment credit confirmation may include, for example, the amount credited to the merchant's FSP account, with the consumer ID, and the inventory purchased. The payment credit confirmation may be sent, for example, to IP-connected, secondary merchant device 110 using SMS or e-mail. At step 414 or step 415, in scenario 1 or scenario 2 respectively, the FSP 102 may send a transaction confirmation message to the consumer to inform the consumer of the debit on consumer's FSP account. The transaction confirmation message may be sent to consumer mobile device 104, for example, using SMS or email via MNO 112. At step 416 or step 417, respectively in scenario 1 or scenario 2, the FSP 102 may generate a receipt 118 (see FIG. 1) of the transaction for either or both of the consumer's and merchant's FSP account records, with merchant information placed in the consumer's FSP online account for potential refunds or returns, and the FSP 102 may update the consumer credentials.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as processing component (e.g., processor, micro-controller, digital signal processor (DSP), etc.), system memory component (e.g., RAM), static storage component (e.g., ROM), disk drive component (e.g., magnetic or optical), network interface component (e.g., modem or Ethernet card), display component (e.g., CRT or LCD), input component (e.g., keyboard or keypad), and/or cursor control component (e.g., mouse or trackball). In one embodiment, disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted.

In various embodiments, execution of instruction sequences for practicing the invention may be performed by a computer system. In various other embodiments, a plurality of computer systems coupled by communication link (e.g., LAN, WLAN, PTSN, or various other wired or wireless networks) may perform instruction sequences to practice the invention in coordination with one another.

Computer system may transmit and receive messages, data, information and instructions, including one or more programs (i.e., application code) through communication link and communication interface. Received program code may be executed by processor as received and/or stored in disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A computer system for providing contactless mobile payment transactions, comprising:
a non-transitory memory; and
one or more hardware processors coupled to the non-transitory memory and configured to read instructions from the non-transitory memory to cause the computer system to perform operations comprising:
receiving, by the computer system, transaction information from a mobile device of a user associated with a contactless proximity communication between the mobile device and a merchant proximity tag associated with a merchant device for a merchant, wherein the merchant proximity tag comprises a merchant tag identifier (ID), and wherein the transaction information comprises the merchant ID, Global Positioning System (GPS) coordinates from a GPS device associated with the mobile device, and product information and price information associated with a transaction between the user and the merchant;
authenticating, by the computer system, the transaction based on the merchant tag ID of the merchant proximity tag associated with the merchant device, the product information and the price information associated with the transaction, and matching a location of the merchant to the GPS coordinates received from the mobile device;
sending, by the computer system, a payment credit confirmation comprising an amount credited to an account of the merchant, an identifier of the mobile device, and one or more details of the transaction between the user and the merchant to a secondary merchant device; and
sending, by the computer system, a confirmation message for the transaction to the mobile device.

2. The system of claim 1, wherein:
the contactless proximity communication involves the mobile device and the merchant proximity tag, the mobile device is associated with a mobile device identifier (ID), the merchant proximity tag is associated with a unique merchant identifier (ID), and the transaction information received by the computer system further comprises the mobile device ID and the unique merchant ID associated with the merchant proximity tag.

3. The system of claim 1, wherein the operations further comprise:
validating the transaction information by matching a consumer ID with a consumer account, matching a merchant ID with a merchant account, and matching the GPS coordinates received from the mobile device with a known location for the merchant.

4. The system of claim 1, wherein the merchant device uses an internet protocol and the computer system sends the payment credit confirmation to the merchant device via the internet protocol.

5. The system of claim 1, wherein the mobile device provides at least one of e-mail or Short Message Service (SMS) and the computer system sends the transaction confirmation message to the mobile device via the e-mail or the SMS.

6. A computer-implemented method for providing contactless mobile payment transactions, comprising:
receiving, by one or more processor devices, transaction information from a mobile device of a user in response to a contactless proximity communication between the mobile device and a merchant proximity tag associated with a merchant device for a merchant, wherein the merchant proximity tag comprises a merchant tag identifier (ID), and wherein the transaction information comprises the merchant tag ID, Global Positioning System (GPS) coordinates from a GPS device associated with the mobile device, and product information and price information associated with a transaction between the user and the merchant;
authenticating, by one or more of the processor devices, the transaction based on the merchant tag ID of the merchant proximity tag associated with the merchant device received from the mobile device, the product information and the price information associated with the transaction received from the mobile device, and based on matching a location of the merchant to the GPS coordinates received from the mobile device;
sending, by one or more of the processor devices, a payment credit confirmation comprising an amount credited to an account of the merchant, an identifier of the mobile device, and one or more details of the transaction between the user and the merchant to a secondary merchant device; and
sending, by the computer system, a confirmation message for the transaction to the mobile device.

7. The computer-implemented method of claim 6, wherein the contactless proximity communication involves a near field communication (NFC) between the mobile device and the merchant proximity tag.

8. The computer-implemented method of claim 6, wherein:
validating the transaction information by matching a consumer ID with a consumer account, matching a merchant ID with a merchant account, and matching the GPS coordinates received from the mobile device with a known location for the merchant.

9. The computer-implemented method of claim 6, wherein the merchant device uses an internet protocol and the computer system sends the payment credit confirmation to the merchant device via the internet protocol.

10. The computer-implemented method of claim 6, wherein the mobile device provides at least one of e-mail or Short Message Service (SMS) and the computer system sends the transaction confirmation message to the mobile device via the e-mail or the SMS.

11. A non-transitory machine-readable medium having stored thereon machine-readable instructions executable to cause a machine to perform operations comprising:
receiving, by a computer system, transaction information from a mobile device of a user in response to a contactless proximity communication between the mobile device and a merchant proximity tag associated with a merchant device for a merchant, wherein the merchant proximity tag comprises a merchant tag identifier (ID), and wherein the transaction information comprises the merchant tag ID, Global Positioning System (GPS) coordinates from a GPS device associated with the mobile device, and product information and price information associated with a transaction between the user and the merchant;
authenticating, by the computer system, the transaction based on the merchant tag ID of the merchant proximity tag associated with the merchant device, the product information and the price information associated with the transaction, and matching a location of the merchant to the GPS coordinates received from the mobile device;
sending, by the computer system, a payment credit confirmation comprising an amount credited to an account of the merchant, an identifier of the mobile device, and one or more details of the transaction between the user and the merchant to a secondary merchant device; and
sending, by the computer system, a confirmation message for the transaction to the mobile device.

12. The non-transitory machine-readable medium of claim 11, wherein:
the contactless proximity communication involves the mobile device and the merchant proximity tag,
the mobile device is associated with a mobile device identifier (ID),
the merchant proximity tag is associated with a unique merchant identifier (ID), and
the transaction information received by the computer system further comprises the mobile device ID and the unique merchant ID associated with the merchant proximity tag.

13. The non-transitory machine-readable medium of claim 11, wherein the operations further comprise:
validating the transaction information by matching a consumer ID with a consumer account, matching a merchant ID with a merchant account, and matching the GPS coordinates received from the mobile device with a known location for the merchant.

14. The non-transitory machine-readable medium of claim 11, wherein the merchant device uses an internet protocol and the computer system sends the payment credit confirmation to the merchant device via the internet protocol.

15. The computer system of claim 1, wherein the operations further comprise:
providing a first account associated with the mobile device;
providing a second account associated with the merchant; and
authenticating the mobile device at least in part based on the transaction information received from the mobile device.

16. The computer system of claim 1, wherein the operations further comprise:
providing a first account for a user associated with the mobile device;
providing a second account associated with the merchant; and
processing the transaction between the first account and the second account at least in part by crediting a payment to the second account and debiting the payment from the first account.

17. The computer-implemented method of claim 6, further comprising:
providing a first account associated with the mobile device;
providing a second account associated with the merchant; and
authenticating the mobile device at least in part based on the transaction information received from the mobile device.

18. The computer-implemented method of claim 6, further comprising:
providing a first account for a user associated with the mobile device;
providing a second account associated with the merchant; and
processing the transaction between the first account and the second account at least in part by crediting a payment to the second account and debiting the payment from the first account.

25. The non-transitory machine-readable medium of claim 11, wherein the operations further comprise:
providing a first account associated with the mobile device;
providing a second account associated with the merchant; and
authenticating the mobile device at least in part based on the transaction information received from the mobile device.

26. The non-transitory machine-readable medium of claim 11, wherein the operations further comprise:
providing a first account for a user associated with the mobile device;
providing a second account associated with the merchant; and
processing the transaction between the first account and the second account at least in part by crediting a payment to the second account and debiting the payment from the first account.
